(19) United States
(12) Patent Application Publication
(10) Pub. No.: US 2014/0022381 A1
(43) Pub. Date: Jan. 23, 2014

(54) RADIOMETRIC MULTI-SPECTRAL OR HYPERSPECTRAL CAMERA ARRAY USING MATCHED AREA SENSORS AND A CALIBRATED AMBIENT LIGHT COLLECTION DEVICE

(71) Applicant: TETRACAM, INC., CHATSWORTH, CA (US)

(72) Inventor: STEVE HEINOLD, WOODLAND HILLS, CA (US)

(21) Appl. No.: 13/944,718

(22) Filed: Jul. 17, 2013

Related U.S. Application Data
(60) Provisional application No. 61/672,598, filed on Jul. 17, 2012.

(51) Int. Cl. G01N 21/27

(52) U.S. Cl. CPC G01N 21/27
USPC 348/135

(57) ABSTRACT

Embodiments pertain to a method and apparatus for imaging discrete bands of the spectrum of a target and calculating the true absorption/reflectance of the target with reference to a static ambient light sensor for each of the bands of the spectrum implemented in the device. In specific embodiments, an array of cameras, each with a separate band pass filter, is used to acquire images simultaneously. Embodiments can allow an operator of a multi-spectral or hyperspectral camera array to create accurate radiometric images of crops, minerals, or other subjects of interest, so that the chemical composition, surface condition, and/or other characteristics can be accurately analyzed. An embodiment can use matched area sensors to separately collect images of the target and a calibration image via a bundle of optical fibers with remotely located, matching, band pass filters.

### CROSS-REFERENCE TO RELATED APPLICATION

The present application claims the benefit of U.S. Provisional Application Ser. No. 61/672,598, filed Jul. 17, 2012, which is hereby incorporated by reference herein in its entirety, including any figures, tables, or drawings.

### BACKGROUND OF INVENTION

Multi-spectral and hyperspectral cameras are used in the field to measure the chemical composition of crops and minerals. Two dimensional sensor arrays can be used to collect images of large areas of interest for later analysis. In some implementations, a small number of sensors is used with a large number of band pass filters, with a mechanism to replace the filters for successive image acquisitions. In others, an array of cameras, each with a separate band pass filter, is used so that the images may be acquired simultaneously.

In order to obtain calibrated results with camera arrays, ground targets of known reflectance are typically used to provide a reference reflected value for the images. Examples of ground targets include painted wooden panels, or vehicles (typically white), whose spectral characteristics have been measured so they can be used as references. In some cases two identical camera arrays have been used, one camera array looking up to measure the incident light, and another camera array flown at an altitude above the earth to collect images of the area of interest on earth. The use of ground targets of known reflectance or additional camera arrays to obtain calibrated results can add costs, time, and/or inconvenience. Accordingly, there is a need in the art for a method and apparatus to obtain multi-spectral and/or hyperspectral images without the need for reference targets within the area of interest, or duplicate cameras looking up to measure the incident light.

### BRIEF SUMMARY

Embodiments of the present invention relate to a method and apparatus for imaging one or more discrete bands of the spectrum of a target and calculating the true absorption/reflectance of the target with reference to a static ambient light sensor for each of the bands of the spectrum implemented in the device. In specific embodiments, an array of cameras, each with a separate band pass filter, is used to acquire images simultaneously.

### BRIEF DESCRIPTION OF DRAWINGS

FIG. 1 shows a block diagram of a radiometric multi-spectral camera array in a specific embodiment of the invention.

FIG. 2 shows an array of band pass filters fitted to the ends of optical fibers that are collected in a bundle for remote positioning.

FIG. 3 shows the fibers collected in an assembly plate that fits over the face of the area sensor for ambient light.

FIG. 4 shows the fiber bundle and sensor plate fitted into a camera array with 5 active image cameras and one camera channel used to make an image of the fiber bundle.

FIG. 5 shows a diagram of a single sensor camera with a color filter array on the sensor that measures ambient light by means of a fiber link located in a corner of the sensor array.

### DETAILED DISCLOSURE

Embodiments of the invention relate to imaging one or more discrete bands of the spectrum of a target and calculating the true absorption/reflectance of the target with reference to a static ambient light sensor for each of the bands of the spectrum implemented in the device. Specific embodiments image one or more discrete bands in the visible light region. Specific embodiments image one or more discrete bands in the NIR and/or IR light region.

Image data can be collected by an array of cameras with matched sensors, where each camera has a narrow pass filter installed to limit its input to the band of light corresponding to the narrow pass filter. An additional matched sensor and camera can then measure ambient light through one or more optical fibers. In an embodiment, a set of optical fibers, having one fiber for each of the supported bands, can be used. Each fiber can have a narrow band pass filter that corresponds to one of the narrow band pass filters in the camera array.

The optical fibers can bring the corresponding ambient light to discrete locations of the sensor, for example, one location for each fiber. The light incident at each discrete location on the sensor can be detected. In an embodiment, the light incident at each location can be digitized and saved at the same instant as the camera array captures images of a selected target. The optical fibers can be as long as necessary to allow the ambient light collection to be done away from any interfering structures.

Using the target images and collected optical fiber data, the data for each band of the target is transformed to a radiometric reflectance value, using calibration constants determined at the time the array of cameras is configured and tested.

The results can be saved as a multi-plane radiometric image of the target. Such multi-plane radiometric image of the target can be used to determine, for example, the molecular composition and surface condition of the target.

This final conversion of the target image, collected optical fiber data, the data for each band of the target, and calibration constants determined at the time the array of cameras is configured and tested, into a radiometric reflectance value, can be performed on a computer that has extracted the raw band samples from each of the imaging cameras and the ambient light camera in the array.

Alternatively, the final conversion of the target image, collected optical fiber data, the data for each band of the target, and calibration constants determined at the time the array of cameras is configured and tested, into a radiometric reflectance value can be performed by one of the cameras in the array using an inter-camera communications technique. In a specific embodiment, to determine a radiometric reflectance value, the signal from the area sensor collecting images is first taken for an object of known reflectance, say 50%, at a known exposure value. As the incident light value is known to be twice the amount of the area sensor signal, the value of the signal from each fiber is assigned a scaling constant that raises its calculated signal to twice the value of the corresponding image sensor. The scaling values are then preserved in memory for future image captures. When a picture is taken of an arbitrary scene, each pixel is converted to reflectance by first scaling the corresponding fiber measurement by the saved constant, then scaling for difference in exposure time versus the calibration sequence. The pixel value is divided by the result, which produces a number in the range of 0 to 1.0, for the radiometric reflectance value. The value can be saved as a binary fixed point number such that 0.5 is expressed as 10000000 for an 8 bit pixel. The most significant bit is the largest binary fraction bit (½).

The filters used for the fibers and imaging cameras can be easily replaceable and/or interchangeable, allowing reconfiguration of the set-up for different bands in the field. In a specific embodiment, a large filter goes over the area sensor and a matching smaller filter over the corresponding fiber. The bands are selected according to the spectral characteristics of the subject, and, in a specific embodiment, each filter is a 2 nm to 40 nm wide segment of the visible and NIR spectrum, which spans 400 nm to 1000 nm. An example set of filters is as follows:

1. 10 nm filter centered at 420 nm
2. 20 nm filter centered at 540 nm
3. 20 nm filter centered at 720 nm
4. 10 nm filter centered at 750 nm
5. 40 nm filter centered at 880 nm
Any band pass filter can be created in the range of the spectrum supported by the instrument. Specific embodiments can utilize filters having a width in the range of 2 nm to 10 nm, 10 nm to 20 nm, 20 nm to 30 nm, 30 nm to 40 nm, 5 nm to 35 nm, 18 nm to 22 nm, 10 nm to 30 nm, and/or 15 nm to 25 nm. Embodiments can use 1, 2, 3, 4, 5, 6, 7, 8, 9, 10, or more bands. The bands can have the same widths or different widths. The bands can overlap or not overlap.

There can be more optical fibers and ambient light collection filters than imaging camera bands, allowing better characterization of the ambient light spectrum, or fewer optical fibers and ambient light collection fibers than imaging camera bands if desired.

The optical fibers can be fitted with different apertures, or have different efficiencies to equalize light measurements through filters of different band widths.

There can be several sensors used to measure ambient light.

The sensors used to measure ambient light can be different in kind from the image sensors in the camera array, or can be the same.

A single sensor camera with a color filter array (CFA) can have a single optical fiber that produces an ambient light measurement patch in the corner of the image.

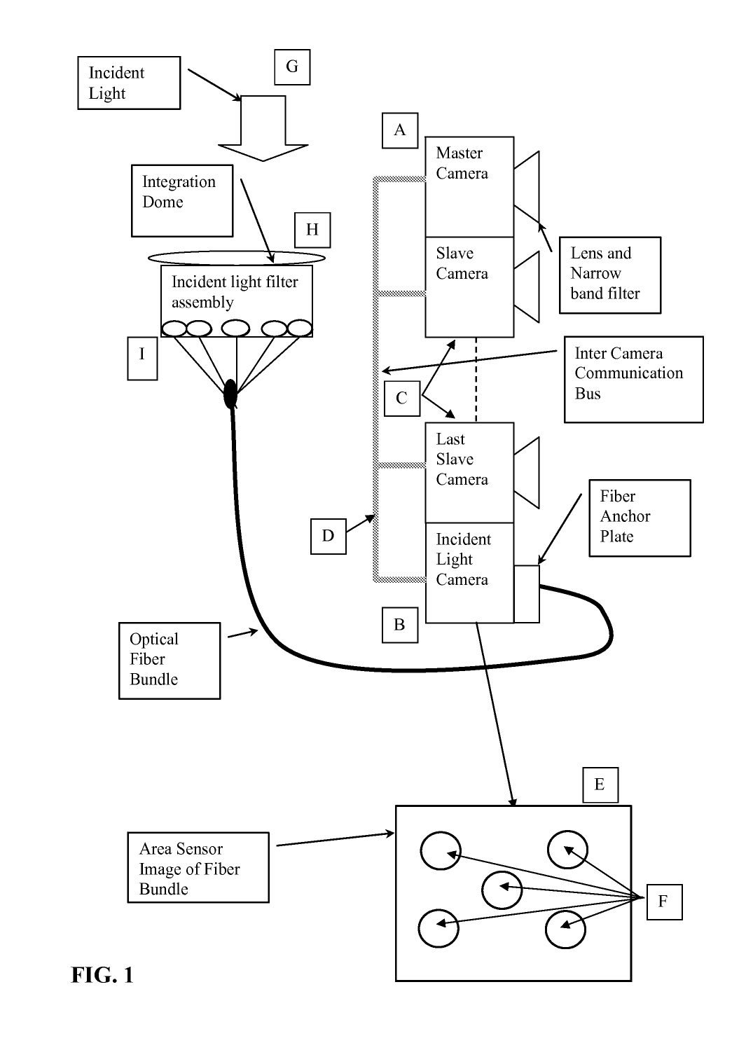

FIG. 1 shows an array of digital still cameras with one camera (A) serving as a master synchronizing camera, and one serving as a measurement camera for incident light (B). Other cameras in the system are slaves (C) that receive calibration and timing information from the master camera (A) over an inter-camera serial communications bus (D). Each of the master and slave cameras is equipped with a unique narrow band pass filter that allows it to see only a small portion of the spectrum. The Master Camera (A) samples the field of view and determines a correct exposure for all the slave cameras (C) and itself based on the objects in the field of view. The incident light measurement camera (B) concurrently samples the fiber bundle which forms an image on its area sensor represented by (E). There is no band pass filter at the sensor end of the fiber bundle. The incident light is diffused through a translucent dome (H) to create a uniform bright spot at the end of the fiber for each band pass filter (I) in the incident light filter assembly. Each band pass filter in the incident light filter assembly matches a filter installed in the master and slave cameras. The incident light camera measures the value of each bright spot (F) on its area sensor, and communicates the value to the slave and master cameras using the inter-camera communications bus (D). The values measured are applied to each pixel in the images of the master and slave cameras so that the final values saved are the percent reflectance in the field of view compared to the value of incident light (G) for that band.

Although FIG. 1 shows a master camera and multiple slave cameras, alternative embodiments can use other configurations, such as multiple slave cameras, and a separate apparatus can receive the input light from the incident light camera (or other sensor) and communicate with all of the cameras. This separate (could be built in) apparatus can perform the reflectance calculation. The set of cameras can still have a master camera for other purposes, such as calculating an exposure time for a key band, and forcing the other bands (cameras) to use the same exposure time. Such functions performed by the master camera, as part of the camera array, can be important in order for the reflectance calculation to come out right for all of the bands (cameras). The incident light assembly can be directed at any angle, such as in the range of 0°-180°, 90°-180°, 135°-180°, 90°-135°, 150°-180°, 170°-180°, 175°-180°, and/or 178°-180°. Preferably, the incident light assembly is directed 180° from the direction of the camera, and, most preferably, on the same axis as the camera. For aerial photography, the camera can be directed straight down and the incident light filter assembly directed up (180° rotation). In agricultural implementations the most accurate measurements are made at midday when the sun is directly overhead.

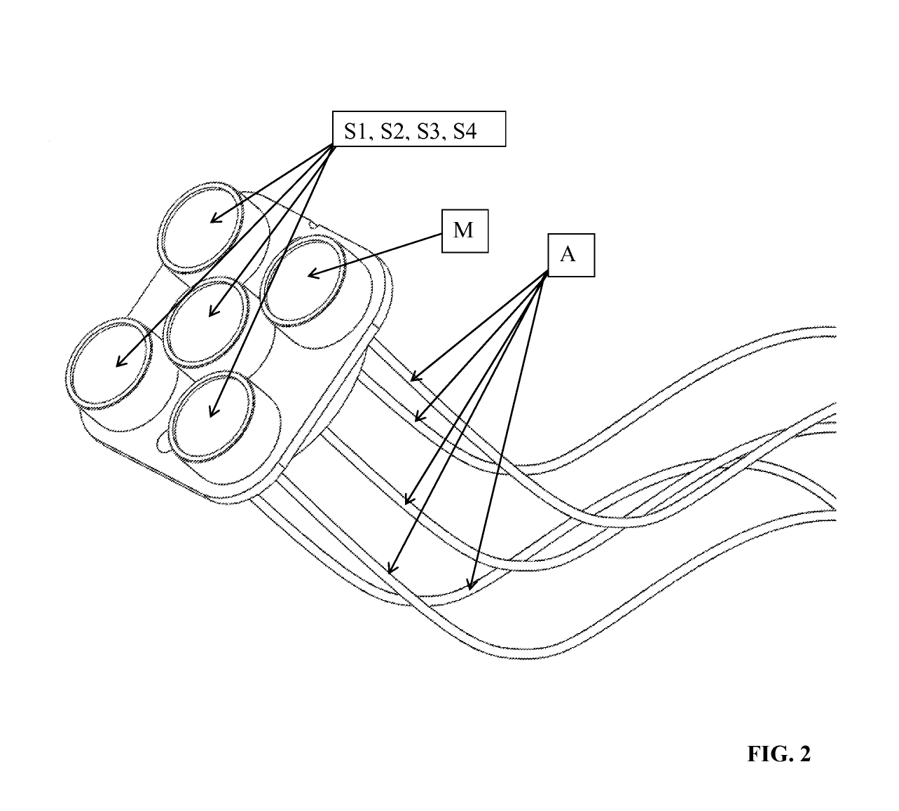

FIG. 2 shows the construction of the incident light filter assembly in a specific embodiment, with the integration dome removed. There is one filter in the assembly that matches the band pass filter for the master camera (M) and one for each of the 4 slave cameras in the specific embodiment shown in FIG. 1 (S1, S2, S3, S4). A single optical fiber (A) is centered behind each filter. The fibers are bundled together as they leave the assembly. Alternative embodiments can incorporate alternative optical fiber arrangements, such as a fiber bundle or image guide.

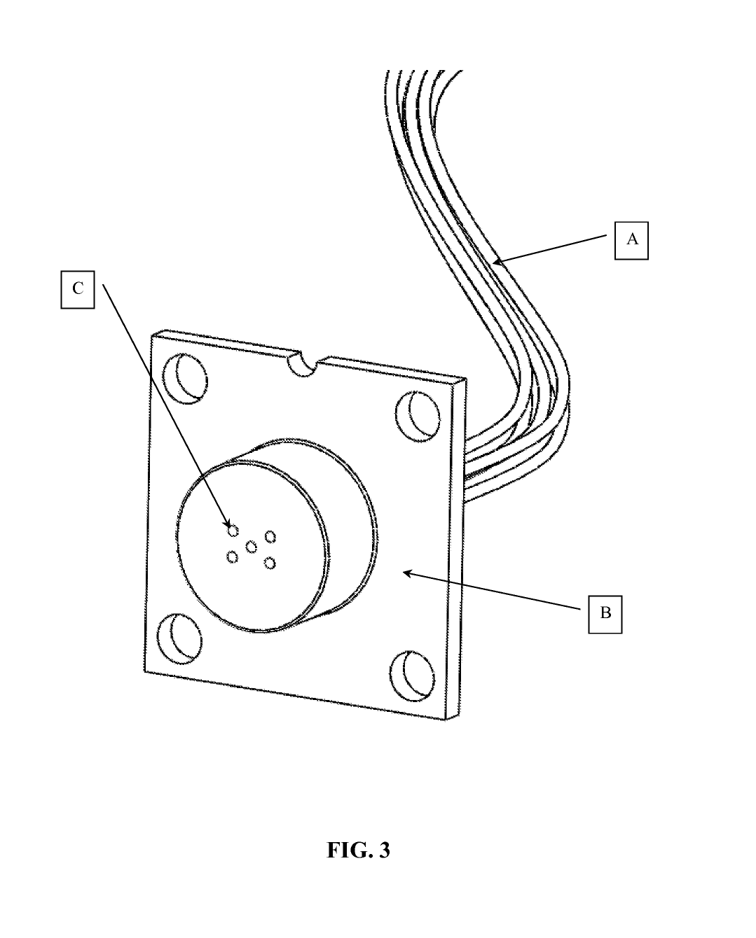

FIG. 3 shows the construction of the other end of the fiber bundle for a specific embodiment. Each fiber (A) from the integration dome assembly is fitted into a receiving hole (C) in the sensor plate assembly (B). The sensor plate assembly is placed directly over the area sensor in the incident light camera to form an image of five bright spots.

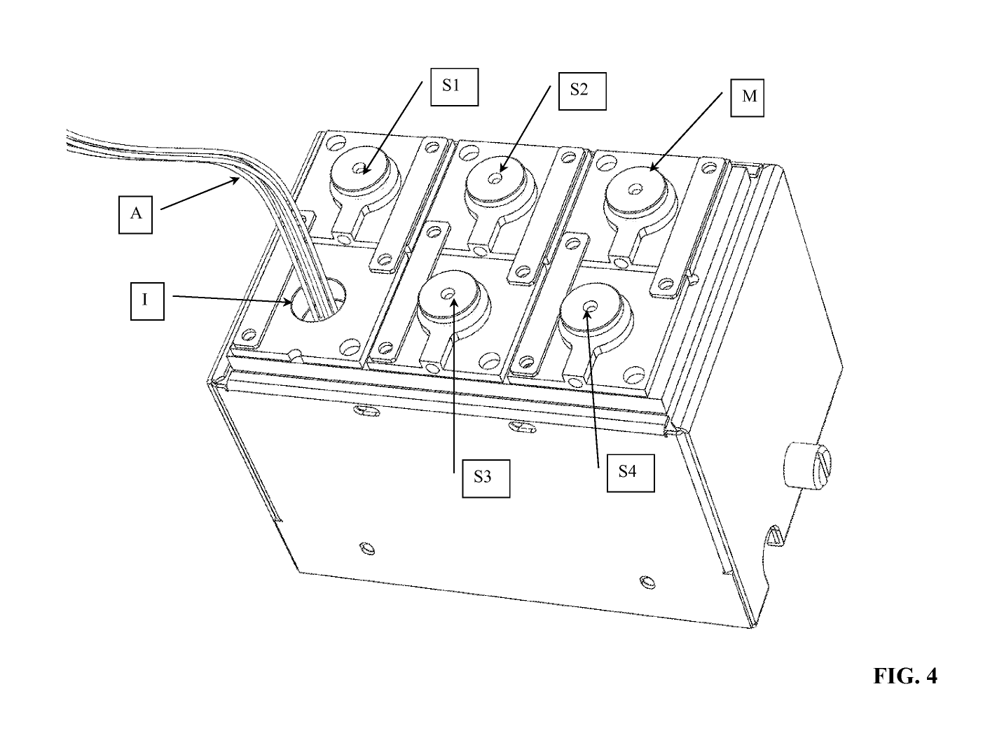

FIG. 4 shows the sensor plate assembly installed in the camera array in the preferred embodiment. The master camera (M) is at one corner of the array, and the incident light measurement camera (I) is at the other. Four slave cameras (S1, S2, S3, and S4) fill the remaining positions in the camera array. In a specific embodiment, each of the slave cameras can have a band pass filter covering a corresponding region of the spectrum for multi-spectral imaging. The fiber bundle (A) is shown leaving the array to a remote mounting point for the incident light filter assembly.

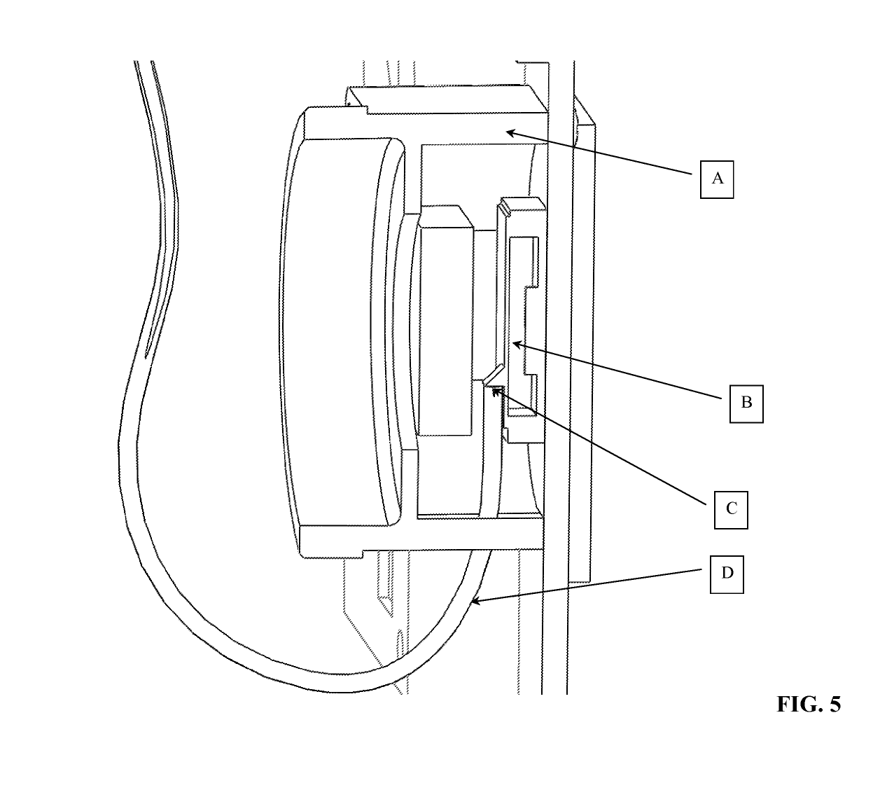

FIG. 5 shows a diagram of a single sensor camera with a color filter array on the sensor that measures ambient light via a fiber link located in a corner of the sensor array. A cutaway view of an area sensor (B) installed behind an optics block (A) is shown, in which a lens is installed to capture images. An optical fiber (D) enters the optics block and is terminated at a small right angle prism (C) which reflects the light in the fiber onto the corner of the area sensor. The individual photosites in the area sensor are covered in an array of filters which allow the ambient light to be measured so the percent reflectance of the pixels in the image can be calculated. The image is formed in the larger area of the sensor unaffected by the installation of the fiber and prism.

Specific embodiments can involve measuring the chemical composition of crops and minerals, or other characteristic(s), of a target on the ground based on images captured by cameras located between 200 m and 1000 m, 100 m and 200 m, 200 m and 300 m, 300 m and 400 m, 400 m and 500 m, 500 m and 600 m, 600 m and 700 m, 700 m and 800 m, 800 m and 900 m, and/or 900 m and 1000 m above ground level (AGL). Of course other altitudes can also be implemented. Preferably, the images are such that each pixel represents less than 20 cm×20 cm, less than 15 cm×15 cm, less than 10 cm×10 cm, less than 5 cm×5 cm, and/or between 12 cm×12 cm and 8 cm×8 cm of the target.

Aspects of the invention, such as calculating absorption/reflectance of a target, calibration constants, radiometric images, multi-plane radiometric images, molecular composition, surface conditions, scaling constants, and/or chemical composition, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A system for acquiring information regarding a target, comprising:
at least one imager corresponding to at least one spectrum band;
a corresponding at least one first band-pass filter, wherein light incident on the system from a first direction passes through the at least one first band-pass filter so as to allow incident light from the first direction in each of the at least one spectrum bands to incident on the corresponding imager of the at least one imager and prevent incident light from the first direction outside of each of the corresponding spectrum band from incidenting on the corresponding imager of the at least one imager;
one or more sensor; and
a corresponding at least one second band-pass filter, wherein light incident on the system from a second direction passes through the at least one second band-pass filter so as to allow incident light from the second direction in each of the at least one spectrum band to incident on the one or more sensor and prevent incident light from the second direction outside of each of the corresponding spectrum band from incidenting on the one or more sensor.

2. The system accordingly to claim 1,
wherein the at least one imager is a plurality of imagers corresponding to a plurality of spectrum bands;
wherein the corresponding at least one first band-pass filter is a corresponding plurality of first band-pass filters, wherein light incident on the system from the first direction passes through the plurality of first band-pass filters so as to allow incident light from the first direction in each of the plurality of spectrum bands to incident on the corresponding imager of the plurality of imagers and prevent incident light from the first direction outside of each of the corresponding spectrum band from incidenting on the corresponding imager of the plurality of imagers, and
wherein the corresponding at least one second band-pass filter is a corresponding plurality of second band-pass filters, wherein light incident on the system from the second direction passes through the plurality of second band-pass filters so as to allow incident light from the second direction in each of the plurality of spectrum bands to incident on the one or more sensor and prevent incident light from the second direction outside of each of the corresponding spectrum bands from incidenting on the one or more sensor.

3. The system according to claim 2, further comprising:
a corresponding plurality of optical fibers, wherein the incident light from the second direction in the corresponding spectrum band output from the corresponding second band-pass filter of the plurality of second band-pass filters is passed to the one or more sensor via the corresponding optical fiber of the plurality of optical fibers.

4. The system according to claim 2,
wherein the plurality of imagers and the one or more sensor is formed by a single area sensor,
wherein the plurality of second band-pass filters is a corresponding plurality of color filters of the single area sensor.

5. The system according to claim 2, wherein each spectrum band of the plurality of spectrum bands has a corresponding band width in a range between 2 nm and 40 nm.

6. The system according to claim 2, wherein the second direction is at least 175 degrees from the second direction.

7. The system according to claim 2, wherein the plurality of first band-pass filters and the plurality of first band-pass filters are matched.

8. The system according to claim 2, wherein the system is configured such that incident light from the second direction in each of the plurality of spectrum bands is simultaneously incident on the one or more sensor.

9. The system according to claim 1, further comprising:
a processor, wherein the processor is configured to produce a spectral image from the incident light from the first direction in the at least one spectrum band incident on the at least one imager and the incident light from the second direction in the at least one spectrum band incident on the one or more sensor.

10. The system according to claim 2, further comprising:
a processor, wherein the processor is configured to produce a multi-spectral image from the incident light from the first direction in the plurality of spectrum bands incident on the plurality of imagers and the incident light from the second direction in the plurality of spectrum bands incident on the one or more sensor.

11. The system according to claim 2, wherein the incident light from the first direction includes light reflected from a target, wherein the incident light from the first direction in the plurality of spectrum bands incident on the plurality of imagers and the incident light from the second direction in the plurality of spectrum bands incident on the one or more sensor provides information regarding a chemical composition of the target.

12. The system according to claim 1, further comprising:
a processor, wherein the processor is configured to produce a corresponding at least one radiometric reflectance value for the at least one spectrum band.

13. The system according to claim 2, further comprising:
a processor, wherein the processor is configured to produce a corresponding plurality of radiometric reflectance values for the plurality of spectrum bands.

14. A method for acquiring information regarding a target, comprising:
providing at least one imager corresponding to at least one spectrum band;
providing a corresponding at least one first band-pass filter, wherein light incident on the system from a first direction passes through the at least one first band-pass filter so as to allow incident light from the first direction in each of the at least one spectrum bands to incident on the corresponding imager of the at least one imager and prevent incident light from the first direction outside of each of the corresponding spectrum band from incidenting on the corresponding imager of the at least one imager;
providing one or more sensor;
providing a corresponding at least one second band-pass filter, wherein light incident on the system from a second direction passes through the at least one second band-pass filter so as to allow incident light from the second direction in each of the at least one spectrum band to incident on the one or more sensor and prevent incident light from the second direction outside of each of the corresponding spectrum band from incidenting on the one or more sensor; and
producing a spectral image from the incident light from the first direction in the at least one spectrum band incident on the at least one imager and the incident light from the second direction in the at least one spectrum band incident on the one or more sensor.

15. The method according to claim 14,
wherein providing at least one imager corresponding to at least one spectrum band comprises providing a plurality of imagers corresponding to a plurality of spectrum bands;
wherein providing a corresponding at least one first band-pass filter comprises providing a corresponding plurality of first band-pass filters, wherein light incident on the system from a first direction passes through the plurality of first band-pass filters so as to allow incident light from the first direction in each of the plurality of spectrum bands to incident on the corresponding imager of the plurality of imagers and prevent incident light from the first direction outside of each of the corresponding spectrum bands from incidenting on the corresponding imager of the plurality of imagers;
wherein providing a corresponding at least one second band-pass filter comprises providing a corresponding plurality of second band-pass filters, wherein light incident on the system from a second direction passes through the plurality of second band-pass filters so as to allow incident light from the second direction in each of the plurality of spectrum bands to incident on the one or more sensor and prevent incident light from the second direction outside of each of the corresponding spectrum bands from incidenting on the one or more sensor; and
wherein a spectral image from the incident light from the first direction in the at least one spectrum band incident on the at least one imager and the incident light from the second direction in the at least one spectrum band incident on the one or more sensor comprises producing a multi-spectral image from the incident light from the first direction in the plurality of spectrum bands incident on the plurality of imagers and the incident light from the second direction in the plurality of spectrum bands incident on the one or more sensor.

16. The method according to claim 15, further comprising:
providing a corresponding plurality of optical fibers, wherein the incident light from the second direction in the corresponding spectrum band output from the corresponding second band-pass filter of the plurality of second band-pass filters is passed to the one or more sensor via the corresponding optical fiber of the plurality of optical fibers.

17. The method according to claim 15,
wherein the plurality of imagers and the one or more sensor is formed by a single area sensor,
wherein the plurality of second band-pass filters is a corresponding plurality of color filters of the single area sensor.

18. The method according to claim 15, wherein each spectrum band of the plurality of spectrum bands has a corresponding band width in a range between 2 nm and 40 nm.

19. The method according to claim 15, wherein the second direction is at least 175 degrees from the second direction.

20. The method according to claim 15, wherein the plurality of first band-pass filters and the plurality of first band-pass filters are matched.

21. The method according to claim 15, wherein incident light from the second direction in each of the plurality of spectrum bands is simultaneously incident on the one or more sensor.

22. The method according to claim 14, further comprising:
producing a spectral image from the incident light from the first direction in the at least one spectrum band incident on the at least one imager and the incident light from the second direction in the at least one spectrum band incident on the one or more sensor.

23. The method according to claim 15, further comprising:
producing a multi-spectral image from the incident light from the first direction in the plurality of spectrum bands incident on the plurality of imagers and the incident light from the second direction in the plurality of spectrum bands incident on the one or more sensor.

24. The method according to claim 15, further comprising:
producing information regarding a chemical composition of the target from the incident light from the first direction includes light reflected from a target, wherein the incident light from the first direction in the plurality of spectrum bands incident on the plurality of imagers and the incident light from the second direction in the plurality of spectrum bands incident on the one or more sensor provides.

25. The method according to claim 14, further comprising:
producing a corresponding at least one radiometric reflectance value for the at least one spectrum band.

26. The method according to claim 15, further comprising:
producing a corresponding plurality of radiometric reflectance values for the plurality of spectrum bands.
